(19) United States
(12) Patent Application Publication
(10) Pub. No.: US 2022/0342416 A1
(43) Pub. Date: Oct. 27, 2022

(54) CONTROL SYSTEM OF AIR VEHICLE FOR URBAN AIR MOBILITY

(71) Applicants: Hyundai Motor Company, Seoul (KR); Kia Corporation, Seoul (KR)

(72) Inventors: Min Woo Han, Hwaseong (KR); Jin Hyuck Heo, Seoul (KR)

(21) Appl. No.: 17/715,883

(22) Filed: Apr. 7, 2022

(30) Foreign Application Priority Data
Apr. 21, 2021 (KR) 10-2021-0051446

(51) Int. Cl. G05D 1/00; G05D 1/08; G05D 1/04; G05D 1/06; G05D 1/10; H04W 4/46

(52) U.S. Cl. CPC G05D 1/0016; G05D 1/0044; G05D 1/085; G05D 1/042; G05D 1/0669; G05D 1/0676; G05D 1/104; H04W 4/46

(57) ABSTRACT

A control system of an air vehicle for urban air mobility (UAM) is provided. A human-machine interface (HMI) system enables people to more easily control the air vehicle for UAM with a familiar method. The control system includes a steeling wheel operated for steering of the air vehicle, an accelerator pedal operated for acceleration of the air vehicle, and a decelerator pedal operated for deceleration and braking of the air vehicle. An altitude designating device selects and designates a target altitude and a controller generates a control command for adjusting altitude, acceleration, deceleration and braking, and steering of the air vehicle, based on air vehicle driving information. A drive device is then operated according to the control command generated from the controller.

### CROSS REFERENCE TO RELATED APPLICATION

The present application claims priority to Korean Patent Application No. 10-2021-0051446, filed Apr. 21, 2021, the entire contents of which is incorporated herein for all purposes by this reference.

### BACKGROUND

### Field of the Disclosure

The present disclosure relates generally to a control system of an air vehicle and, more particularly, to a flight control system capable of allowing people to more easily control an air vehicle for urban air mobility (UAM) by a similar method to controlling a conventional automobile.

### Description of the Related Art

Recently, a vertical take-off and landing air vehicle (VTOL) capable of taking off and landing in a narrow space and having improved degree of freedom in flight has been actively reviewed as UAM of the future. A short take-off and vertical landing (STOVL) air vehicle of the tiltrotor method may be a representative vertical take-off and landing air vehicle, but with the recent development of electrification technology, interest in a drone-type vertical take-off and landing air vehicle having multiple rotors has been increased. As an example, a quadcopter having 4 rotors is known as the drone-type vertical take-off and landing air vehicle, and the quadcopter may be used as an air vehicle for UAM.

FIG. 1 is a view showing the quadcopter that is an electric drone-type vertical take-off and landing air vehicle, and as shown in the drawing, the electric drone 1 such as the quadcopter, etc. is capable of yaw, roll, and pitch movement. Human-machine interface (HMI) is used to control the quadcopter as shown in FIG. 2. FIG. 2 is a schematic view showing an example of a conventional HMI for controlling the quadcopter, wherein the drone may move forward/backward, left/right, and up/down, or rotate left/right in response to a direction of controlling a lever 2 of a controller.

As described above, the electric drone may perform forward and backward, and transverse movement by adjusting rotation velocity and direction of the rotors, and a driver can make a desired motion by combining complex form of control input as shown in FIG. 2. However, the controller or the driving input device as shown in FIG. 2 has an advantage that 6-way flight freedom, such as forward/backward, left/right, up/down (ascending/descending), yaw, pitch, roll can be utilized to the fullest, but it is difficult for ordinary people to operate the air vehicle because the driver should use the complex and unfamiliar driving input device to control the air vehicle.

Additionally, HMI for controlling the vertical take-off and landing air vehicle or other air vehicles for UAM can fully utilize the 6-way flight freedom, but the method is complex that it is not suitable for use people without specialized training and experience. Hereinabove, the electric drone-type HMI of the vertical take-off and landing air vehicle was described, but it is impossible for people to control a helicopter-type HMI without any education or training.

Accordingly, specialized education and training are provided for pilot selected to control the vertical take-off and landing air vehicle, and after complication of the training, only a small number of experts who have accumulated flight experience for a predetermined amount of time are permitted to control and operate an air vehicle. Therefore, a conventional complex control method or HMI of a vertical take-off and landing air vehicle is not suitable for the air vehicle for UAM that should be widely used for ordinary people. In addition, the electric drone is capable of pure transverse movement, unlike movement characteristics of existing ground mobility, so the electric drone has characteristics of capable of yaw movement and decoupling of transverse movement.

The above described characteristics may significantly increase the movement freedom of the drone, but in drones with passengers, the driver and passengers may feel discomfort such as motion sickness, dizziness, etc. Moreover, when boarding the drone, due to the movement characteristics, it is possible to perform air vehicle movement that is unfamiliar to the driver or passengers, e.g. movement without difference between forward/backward/left/right, so the driver and passenger can feel more uncomfortable.

Accordingly, there is a need for a HMI device and control algorithm for controlling a drone, which are capable of overcoming the limitation in movement control of the existing electric drone and of providing familiar movement characteristics to the driver and passengers.

### SUMMARY

Accordingly, the present disclosure has been made keeping in mind the above problems occurring in the related art, and the present disclosure is intended to propose a flight control system capable of allowing people to more easily control an air vehicle for UAM.

The present disclosure is not limited to the objective mentioned above, and other objectives not mentioned are clearly understood by those who are ordinarily skilled in the art to which the present disclosure belongs (hereinbelow, referred to ‘those skilled in the art’) from the following description.

In order to achieve the above objective, according to one aspect of the present invention, a control system of an air vehicle for urban air mobility may include: a steering wheel configured to be operated for steering of the air vehicle; an accelerator pedal configured to be operated for acceleration of the air vehicle; a decelerator pedal configured to be operated for deceleration and braking of the air vehicle; an altitude designating device configured to select and designate a target altitude where the air vehicle flies; a controller configured to generate a control command for controlling altitude, acceleration, deceleration and braking, and steering of the air vehicle, based on air vehicle driving information including driving input information in response to the operation of the steering wheel, the accelerator pedal, the decelerator pedal, and the altitude designating device; and a drive device configured such that drive thereof is controlled according to the control command generated from the controller.

According to the present disclosure, with the control system for UAM, the vertical take-off and landing process is automated and the steering wheel, and the accelerator pedal and brake pedal of a conventional automobile that are familiar to a driver are applied to the control system, so that the driver may efficiently control or operate the air vehicle with the same method and principle as driving a conventional automobile and people may more easily control the air vehicle that has previously been driven by only highly trained and specialized experts.

During the control, the air vehicle response similar to response of a conventional automobile can be expected, so that a driver who is an existing vehicle driver may efficiently control the air vehicle without a high level of training, and a driver's license test for the air vehicle may be conducted by adding a process (altitude, etc.) to the existing driver's license test The air vehicle may move by the movement method familiar to the driver and passengers, and people may use the air vehicle without discomfort, such as motion sickness, dizziness, etc., during flight of the air vehicle.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is a view showing a quadcopter that is an electric drone-type vertical take-off and landing air vehicle.

FIG. 2 is a schematic view showing an example of a conventional driving input device for controlling the quadcopter.

FIGS. 3 to 7 are views showing a flight principle of a drone-type vertical take-off and landing air vehicle having multiple rotors.

FIG. 8 is a view showing a driving input device in an air vehicle to which a control method according to the present disclosure is applied.

FIG. 9 is a block diagram showing the structure of a control system in the air vehicle to which the control method according to the present disclosure is applied.

FIG. 10 is a flowchart showing an operation process of an air vehicle for UAM according to the present disclosure.

FIG. 11 is a view showing an example of virtual spatial road layers of planes per altitude according to the present disclosure.

FIG. 12 is a view showing an example of setting an intersection of the virtual spatial road layers according to the present disclosure.

FIG. 13 is a control block diagram of the air vehicle for UAM according to an embodiment of the present disclosure.

FIG. 14 is a view showing an algorithm of control logic for ascending and descending, and maintaining altitude of the air vehicle according to the embodiment of the present disclosure.

FIGS. 15 and 16 are views showing an algorithm of control logic for acceleration and deceleration of the air vehicle in the embodiment of the present disclosure.

FIGS. 17A, 17B, and 17C are views showing comparison between a turning method of the conventional drone and a turning method of the air vehicle for UAM according to the present disclosure.

FIG. 18 is a view showing an algorithm of control logic for turning the air vehicle according to the embodiment of the present disclosure.

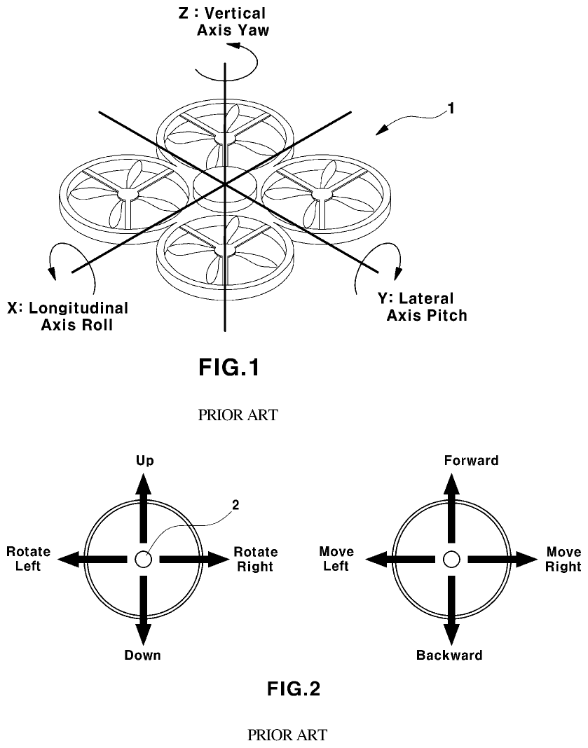

### DETAILED DESCRIPTION

In the following description, the structural or functional description specified to an exemplary embodiment according to the concept of the present invention is intended to describe the exemplary embodiment, and an embodiment described herein may be changed in various ways and various shapes. However, it should be understood that exemplary embodiments according to the concept of the present invention are not limited to the embodiment which will be described hereinbelow with reference to the accompanying drawings, but all of modifications, equivalents, and substitutions are included in the scope and spirit of the invention.

It will be understood that although the terms first and/or second, etc. may be used herein to describe various elements, these elements should not be limited by these terms. These terms are only used to distinguish one element from another element For instance, a first element discussed below could be termed a second element without departing from the teachings of the present invention Similarly, the second element could also be termed the first element

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referral to as being “connected directly to” or “coupled directly to” another element, it may be connected to or coupled to another element without the other element intervening therebetween. Further, the terms used herein to describe a relationship between elements, that is, “between”, “directly between”, “adjacent”, or “directly adjacent” should be interpreted in the same manner as those described above.

Like reference numerals are used to identify like components throughout different drawings. The terminology used herein is for the purpose of describing a particular embodiment only and is not intended to limit the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Hereinbelow, an embodiment of the present disclosure will be described in detail with reference to the accompanying drawings. The present disclosure is intended to provide a control system to enable ordinary people to operate an air vehicle for urban air mobility in a familiar way.

The present disclosure may be applied to the air vehicle for urban air mobility (hereinbelow, which is referral to UAM), in detail, the vertical take-off and landing air vehicle capable of moving and flying in a desired direction, velocity, and posture at a desired altitude through a driving control by a driver seated in the air vehicle. More particularly, the present disclosure may be applied to the electric drone-type air vehicle having multiple rotors, and as an example thereof, the present disclosure may be applied to the quadcopter having 4 rotors.

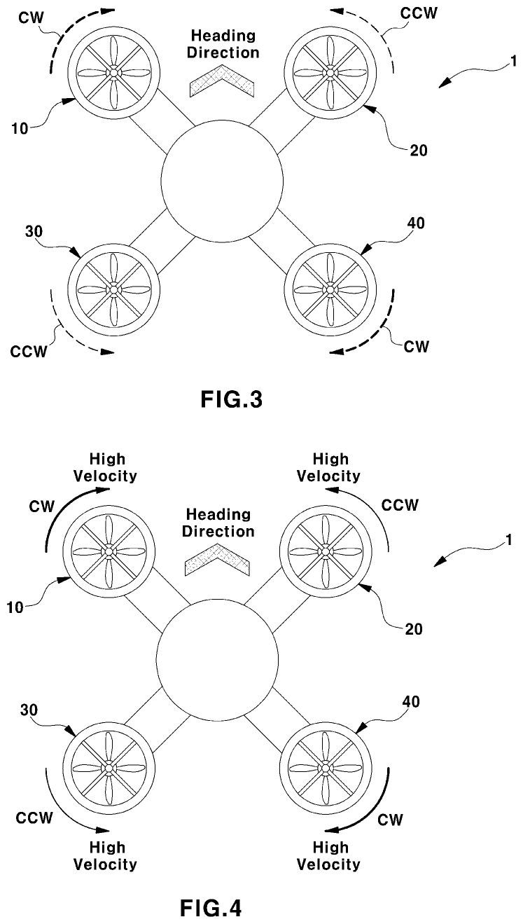

Prior to the description of the embodiment of the present disclosure, a flight principle of the drone-type vertical take-off and landing air vehicle having multiple rotors will be described as follows with reference to FIGS. 3 to 7. FIGS. 3 to 7 show an example of the quadcopter. The 4 rotors mounted to the vertical take-off and landing air vehicle 1 may include a first rotor 10 and a second rotor 20 arranged at the front left and right of the air vehicle, and a third rotor 30 and a fourth rotor 40 arranged at the rear left and right of the air vehicle. The first rotor 10 and the fourth rotor 40 may be arranged diagonally to each other and the second rotor 20 and the third rotor 30 may be arranged diagonally to each other.

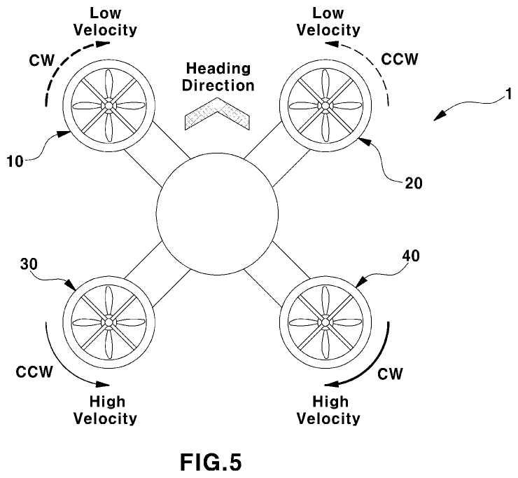

Referring to FIG. 3, for take-off and landing, and flight of the vertical take-off and landing air vehicle 1, fundamentally, the first rotor 10 and the fourth rotor 40 rotate clockwise (CW), and the second rotor 20 and the third rotor 30 rotate counterclockwise (CCW). As a rotational velocity and a direction are adjusted, movement of the vertical take-off and landing air vehicle, such as ascending and descending, forward and backward movements, transverse movement, left and right rotations, etc., may be performed. For example, when the vertical take-off and landing air vehicle 1 ascends, the first rotor 10 and the fourth rotor 40 may rotate CW at a high velocity and simultaneously and the second rotor 20 and the third rotor 30 may rotate CCW at a high velocity, as shown in FIG. 4. When the vertical take-off and landing air vehicle 1 moves forward, the first rotor 10 and the second rotor 20 may rotate at a low velocity and simultaneously the third rotor 30 and the fourth rotor 40 may rotate at a high velocity (forward pitching), as shown in FIG. 5.

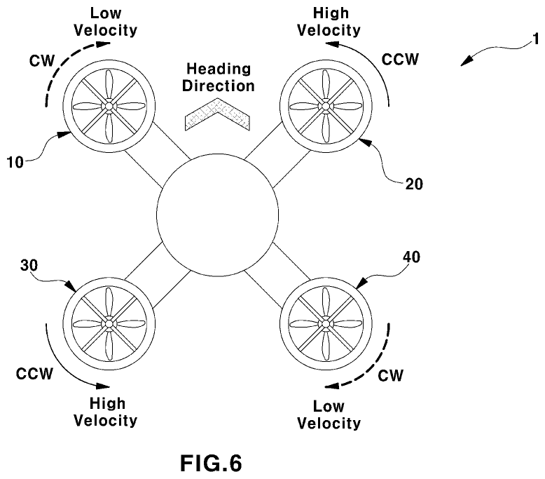

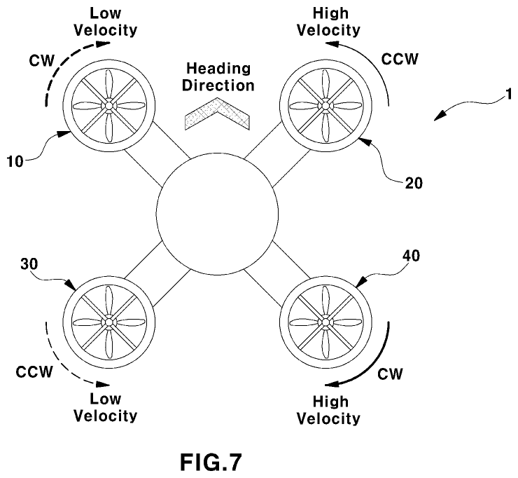

Furthermore, when the vertical take-off and landing air vehicle 1 turns to the right, the first rotor 10 and the fourth rotor 40 may rotate CW at a low velocity and simultaneously the second rotor 20 and the third rotor 30 may rotate CCW at a high velocity (rotor moment asymmetry state), as shown in FIG. 6. When the vertical take-off and landing air vehicle 1 moves to the left, the first rotor 10 and the third rotor 30 may rotate at a low velocity and simultaneously the second rotor 20 and the fourth rotor 40 may rotate at a high velocity (leftward pitching state), as shown in FIG. 7.

In addition, forward and backward acceleration of the vertical take-off and landing air vehicle 1 may be controlled by forward pitching or backward pitching of a vehicle body (air vehicle) while adjusting the lift of the front rotors (first and second rotors) or the rear rotors (third and fourth rotors). Furthermore, lateral acceleration of the vertical take-off and landing air vehicle 1 may be adjusted by left roll or right roll of the vehicle body while adjusting the lift of the left rotors (first and third rotors) or the right rotors (second and fourth rotors). Furthermore, yaw movement (turning movement) of the vertical take-off and landing air vehicle 1 may be adjusted by using vehicle body moment in response to difference between velocities of the rotors that are arranged diagonally.

Meanwhile, the present disclosure uses the above-described flight and control principle, but the present disclosure is improved in the control system including a driving input device (control device) that is controlled by the driver for controlling and operating the movement of the air vehicle. In other words, unlike an operation device used in the conventional drone-type air vehicle as shown in FIG. 2, the air vehicle for UAM to which the present disclosure is applied uses the control system having a shape and an operation method similar to a driving device of a conventional automobile.

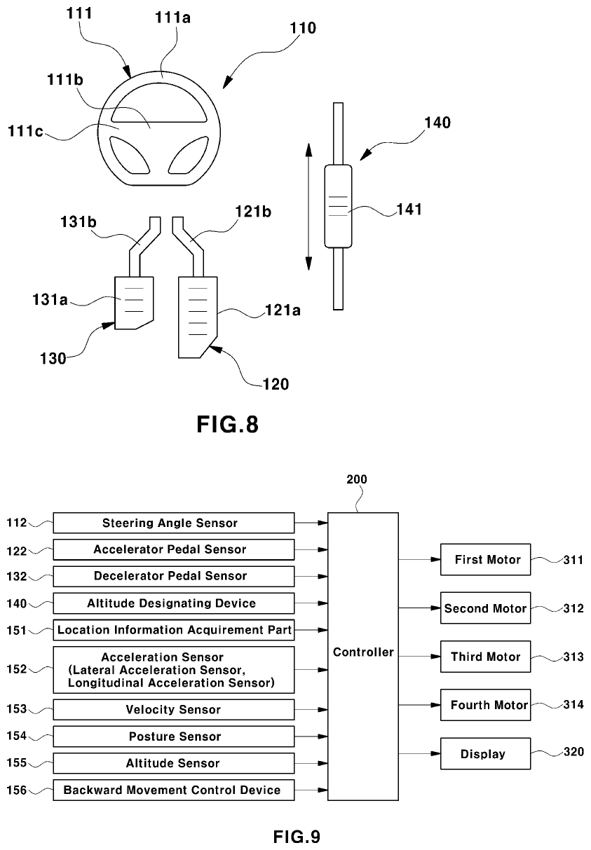

FIG. 8 is a view illustrating the driving input device of the control system in the air vehicle according to the present disclosure, and a front view schematically showing elements of the driving input drive (control device) mounted to a driver seat FIG. 9 is a block diagram showing the structure of the control system in the air vehicle according to the present disclosure.

As shown in the drawings, the driving input device similar to a driving input device of a conventional automobile may be applied to the drive seat (cockpit) in the air vehicle for UAM. In other words, the driving input device of the air vehicle for UAM according to the present disclosure may include a steering wheel assembly 110 provided to be rotated-operated by a hand of the driver (operator), an accelerator pedal 120 and a decelerator pedal 130 provided to be pressed-operated by a foot of the driver, and an altitude designating device 140 provided to be manipulated by a hand of the driver for selecting and designating a flight altitude of the air vehicle. In addition, the driving input device of the air vehicle for UAM may include a backward movement control device, wherein the backward movement control device (reference numeral 156 in FIG. 9) is provided to be operated for moving the air vehicle backward.

The steering wheel assembly 110 includes a steering shaft (not shown) and a steering wheel 111 having a similar shape to a steering wheel of a conventional automobile, and among the elements, the steering wheel 111 may include a rim portion 111a, a boss portion 111b, and a spoke portion 111c connecting between the rim portion 111a and the boss portion 111b. The steering shaft is coupled to the boss portion 111b to integrally rotate with the steering wheel 111, and the steering shaft is rotatably coupled to the vehicle body of the air vehicle. Whereby, the steering wheel has the structure in which the whole steering wheel is rotatably supported to the vehicle body by the steering shaft.

The steering wheel assembly 110 may include a steering angle sensor 112 configured to detect a rotation angle, i.e. a steering angle of the steering wheel when the driver operates the steering wheel 111. The steering angle sensor 112 of the present disclosure may adopt a sensor same as a steering angle sensor for an automobile provided at a steering shaft of an automobile as the steering angle sensor 112. The steering angle sensor 112 may be configured to output an electrical signal in response to the detected steering angle, and is to input the signal to a controller 200. The signal output by the steering angle sensor 112, i.e. a steering angle detection signal representing a steering angle, may be input to the controller 200.

In addition, the accelerator pedal 120 and the decelerator pedal 130 may be configured to adjust longitudinal driving (acceleration and deceleration) and braking of the air vehicle, and the accelerator pedal 120 is a pedal operated by the driver to accelerate the air vehicle, and the decelerator pedal 130 is a pedal operated by the driver to decelerate and brake the air vehicle. Each of the accelerator pedal 120 and the decelerator pedal 130 of the present disclosure may adopt a pedal having the same structure as an accelerator pedal or a brake pedal of the conventional automobile. In other words, each of the accelerator pedal 120 and the decelerator pedal 130 may include a pedal pad 121a, 131a on which the driver steps with his/her foot, a pedal arm 121b, 131b having a first end coupled to the pedal pad to support the pedal pad, and a mounting bracket (not shown) fixed to the vehicle body and to which a second end of the pedal arm is rotatably coupled.

Each of the accelerator pedal 120 and the decelerator pedal 130 may include a sensor configured to output a signal in response to a pedal operation state of the driver. The accelerator pedal 120 includes an accelerator pedal sensor 122 configured to detect an accelerator pedal input value in response to the accelerator pedal operation state as the driver's driving input information, and the decelerator pedal 130 includes a decelerator pedal sensor 132 configured to detect a decelerator pedal input value in response to the decelerator pedal operation state as the driver's driving input information.

The accelerator pedal sensor 122 and the decelerator pedal sensor 132 may be a conventional accelerator pedal sensor (APS) and brake pedal sensor (BPS) that are provided for detecting a pedal position or a pedal depth representing a driver's pedal control amount in the conventional automobile.

The accelerator pedal sensor 122 and the decelerator pedal sensor 132 are configured to input detection signals to the controller 200. In other words, a signal output by the accelerator pedal sensor 122, i.e. a signal representing the accelerator pedal input value, and a signal output by the decelerator pedal sensor 132, i.e. a signal representing the decelerator pedal input value, may be input to the controller 200.

The altitude designating device 140 may be configured to select and designate a driver's desired flight altitude (target altitude) of the air vehicle, and may formed as a sliding knob-type selector as shown in the drawing. The sliding knob-type selector is proposed as an example, so the present disclosure is not limited to the sliding knob-type altitude designating device, and any method in which the driver may easily select and input the desired flight altitude may be adopted without a limitation.

In the sliding knob-type selector shown in the drawing, the driver may select and designate the desired flight altitude by sliding the knob 141 upward and downward. As a position of the knob 141 is adjusted by sliding the knob 141 upward and downward, a flight altitude may be changed at a predetermined interval. The altitude designating device 140 is connected to the controller 200 such that signal input may be performed to the controller 200, and when the driver moves and controls or otherwise manipulates the knob 141, an electrical signal representing the flight altitude selected by operating the knob is input to the controller 200, and thus the controller may be configured to recognize the altitude value selected and input by the driver.

Meanwhile, the control system of an air vehicle for UAM according to the present disclosure may include a location information acquirement part 151. The location information acquirement part 151 may be configured to acquire location information of the air vehicle in real time, and may include a global positioning system (GPS) module. The GPS module communicates with a satellite to acquire the real-time location information where the air vehicle is located, e.g., information about air vehicle's present altitude and longitude.

The control system of an air vehicle for UAM according to the present disclosure may include sensors configured to detect driving information required for controlling moving and posture of the air vehicle, such as acceleration and velocity, posture, altitude, etc. of the air vehicle. In particular, the control system may include an acceleration sensor 152 configured to detect acceleration of the air vehicle, a velocity sensor 153 configured to detect a velocity of the air vehicle, a posture sensor 154 configured to detect a posture of the air vehicle, such as yaw rate information of the air vehicle, etc., and an altitude sensor 155 configured to detect an altitude of the air vehicle.

The posture sensor 154 may be configured to detect a posture of the air vehicle in 3-dimentional space, and may include 3-axis magnetic field sensor or 3-axis gyroscope sensor. The altitude sensor may be a sensor configured to measure an altitude using a radar or measure an altitude using atmospheric pressure measured by a barometer. The sensors may be selectively used to detect rotary acceleration of the air vehicle.

In addition, the flight control system may include known sensors, detection factors, and information acquirement part for acquiring information required for flight of the air vehicle, and for example, may include a distance measurement sensor. The distance measurement sensor may be configured to measure a distance to a surrounding outside object, and ultrasound, infrared, or radar may be used for distance measurement.

According to the present disclosure, the controller 200 may be configured to execute the operation of the drive device for driving the air vehicle, based on a variety of the driving information acquired and collected by a driving information detection part, such as the sensors and the information acquirement part, in the air vehicle. The drive device may include motors 311 to 314 rotating the rotors. For example, the drive device of the quadcopter having 4 rotors may include 4 motors 311 to 314 rotating the 4 rotors.

Furthermore, the control system of the present disclosure may include a display 320 for supporting driving and control of the driver, and the operation of the display 320 may be operated by the controller 200. The display 320 may be an augmented reality-head up display (AR-HUD) provided in the air vehicle.

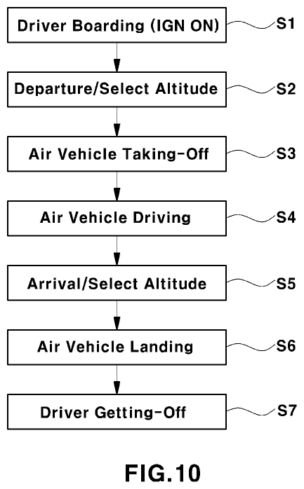

Meanwhile, FIG. 10 is a flowchart showing an operation process of the air vehicle for UAM according to the present disclosure, and the description thereof is as follows. According to the present disclosure, after the driver boards the air vehicle and turns the power on (IGN ON) (Si), the driver may select and designate the desired flight altitude (e.g., 150 m) using the altitude designating device 140 and starts off the air vehicle (S2), whereby the air vehicle takes off and automatically vertical-ascends to the target altitude selected by the driver (S3), and then the air vehicle does not change the altitude thereof during the flight.

As described above, before the departure of the air vehicle, the driver may select and designate the flight altitude in advance using the altitude designating device 140, and the selecting and designating the flight altitude using the altitude designating device 140 may be limited to be performed by the driver only before the departure of the air vehicle. In other words, during flight, it is possible to prevent the driver from further operating the altitude designating device. Of course, the flight altitude may be selected and designated right after the departure, or when necessary, the flight altitude may be changed using the altitude designating device 140 after the departure.

Furthermore, after the departure, when the air vehicle automatically vertical ascends until reaching the target altitude selected by the driver, a hovering control is automatically performed until there is a separate input from the driver, and altitude of the air vehicle may be maintained. Then, the driver moves the air vehicle at the desired direction and a velocity by operating the steering wheel 111, the accelerator pedal 120, and the decelerator pedal 130, and during the driving, an altitude of the air vehicle is continuously maintained at the altitude selected by the driver (S4).

As described above, in a state where the altitude is automatically maintained after vertical ascending of the air vehicle, the driver drives the air vehicle at the desired direction and velocity by controlling only the steering wheel 111, the accelerator pedal 120, and the decelerator pedal 130, and motion of the air vehicle is limited in plane movement within the altitude selected by the driver. In the state where the altitude of the air vehicle is automatically maintained, the driver performs the plane movement of the air vehicle to the target location by operating only the steering wheel and pedals.

After the air vehicle arrives at the target location, the driver operates the altitude designating device 140 to select and designate an altitude where a take-off and landing field is located (S5), whereby the air vehicle lands by automatically vertical-descending to the landing field located at the selected altitude (S6). Then, the driver turns the power of the air vehicle off (IGN OFF) and gets off the air vehicle (S7).

As described above, according to the present disclosure, when the driver designates the target altitude using the altitude designating device, the air vehicle vertically ascends to the target altitude of the air vehicle, and vertical ascending of the air vehicle is automatically performed as the controller 200 operates the motors 311 to 314 that are the drive device.

Furthermore, when the air vehicle has vertically ascended to the target altitude, the driver moves the air vehicle at the desired direction and velocity by operating the steering wheel 111, the accelerator pedal 120, and the decelerator pedal 130, and during driving, the controller 200 may be configured to execute the operation of each of the motors 311 to 314 that are the drive device based on the driving information acquired as the driver operates the steering wheel 111, the accelerator pedal 120, and the decelerator pedal 130.

In addition, the controller 200 allows turning for steering the air vehicle or only minimal roll, pitch, yaw movements required for acceleration, and deceleration of the air vehicle at the target altitude, and the controller 200 moves the air vehicle on a plane. As described above, the air vehicle for the UAM may fly freely in 3-dimensional space, but moves similarly to driving and moving characteristics of the conventional automobile, excluding altitude change or transverse movement

In other words, in the present disclosure, like driving the conventional automobile, the driver operates the steering wheel 111 to perform the steering to control and change a heading direction of the air vehicle to a desired direction, and the driver operates the accelerator pedal 120 to accelerate the air vehicle or operates the decelerator pedal 130 to decelerate or brake the air vehicle. When a velocity of the air vehicle remains at 0 while the driver steps on or otherwise engages the decelerator pedal, the air vehicle may be operated to maintain the driver selection altitude and perform the hovering movement

Therefore, in the present disclosure, after increasing the altitude of the air vehicle, the air vehicle moves to the target location by the planar movement, such as forward movement, left turn, right turn, acceleration, and deceleration, etc., so that the driver and passengers may feel comfortable in the air vehicle without various discomfort such as motion sickness and dizziness that may be felt in the conventional automobile.

The driving control of the air vehicle of the present disclosure is similar to the driving control of the conventional automobile. In other words, the driver may move at the desired direction and velocity by operating the steering wheel 111, the accelerator pedal 120, and the decelerator pedal 130, so that the driving control is easy like in the conventional automobile and people may easily drive the air vehicle without specialized training.

Meanwhile, according to the present disclosure, virtual layers of planes per altitude selected by the altitude designating device 140 within the 3-dimentional space is defined in advance, and in detail, a virtual spatial road layer (VSRL) in which a virtual road (airway) is set within the virtual layers of planes per altitude may be defined, and input and stored in the controller.

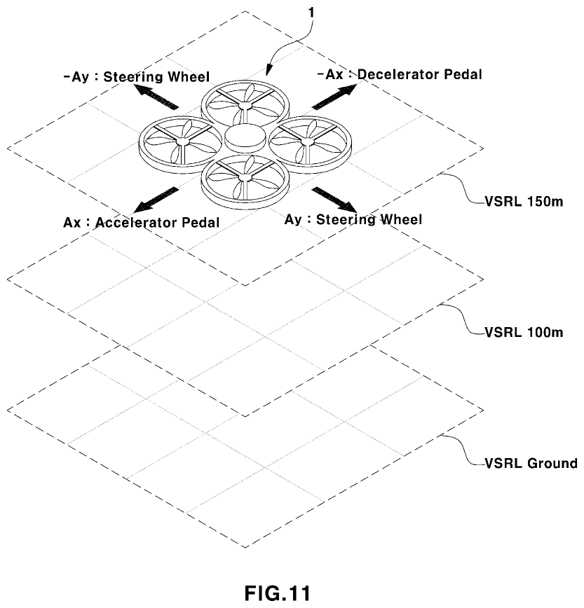

FIG. 11 is a view showing an example of the VSRL of planes per altitude according to the present disclosure, and the VSRL of planes per altitude includes a straight line representing a road and an intersection of straight lines representing an intersection of roads or a take-off and landing field in which the air vehicle may take off and land. The take-off and landing field may be a vertiport in an UAM operation system or be a mobility transfer hub.

While the VSRL of planes per altitude (e.g., ground, 100 m, 150 m) is input and stored in the controller 200 in advance as shown in FIG. 11, the driver designates the desired flight altitude using the altitude designating device 140, whereby a plane of the VSRL corresponding to the designated altitude may be selected from the controller 200. When after the departure, the air vehicle 1 automatically and vertically ascends and reaches the flight altitude selected by the driver, the controller 200 allows the display 320 in the air vehicle 1 to display an image of the VSRL including the virtual plane road at the selected altitude.

The controller 200 may be configured to output an indication of a present location and a moving path of the air vehicle in the VSRL based on the real-time location information of the air vehicle 1 acquired through the location information acquirement part 151. Therefore, while the driver operates the steering wheel 111, the accelerator pedal 120, and the decelerator pedal 130 and moves the air vehicle 1 at a specific altitude, the controller 200 may be configured to perform drive assistant and drive support for continuously guiding the flight path to the driver of the air vehicle so that the air vehicle does not deviate from the road in the VSRL and moves along the road.

In addition, the VSRL of the present disclosure may be information extracted based on the present location information of the air vehicle 1 from map data stored in a storage of the controller 200. The map data may include information about take-off and landing fields (vertiport) in the UAM operation system, roads between the take-off and landing fields, and an intersection. The controller 200 may be configured to extract the VSRL around the air vehicle from the map data in the storage on the basis of the present location information of the air vehicle 1, and may enable the display 320 to display the VSRL.

In the present disclosure, when the driver selects a destination using a vehicle input device (not shown) like a navigation terminal, the controller 200 may be configured to operate the display 320 to display the VSRL and simultaneously to display a present location of the air vehicle and a path to the destination to guide the flight to the driver. A virtual traffic light system may be applied to the present disclosure, when the drive assist and support is performed to guide the flight path to the driver by displaying the VSRL of the selected altitude and the location of the air vehicle 1 on the display 320 and allowing the air vehicle to move along the load in the VSRL. In other words, a virtual traffic light is marked at each intersection in the VSRL on the display.

When multiple air vehicles flying at the same altitude pass through a specific intersection in the VSRL displayed on the display at the same time, the virtual traffic light system informs the driver of a point of passing the intersection corresponding to each air vehicle through the virtual traffic light, so that the air vehicles may pass through the intersection at respective designated point and order without a collision accident.

The virtual traffic light system is applied on the intersection in the VSRL by simulating the actual traffic light system that is provided on the ground intersection and operated for the conventional automobile. In other words, as pass and stop signals are provided successively to a driver for each air vehicle through the virtual traffic light displayed on the intersection in the VSRL, each air vehicle may be guided to pass through the intersection at the designated point successively.

Controllers of the air vehicles flying toward the intersection share location information thereof with each other. In addition, the controllers may communicate with each other and determine a traffic priority of passing the intersection for all air vehicles based on the location information of the air vehicles, and share the determined traffic priority with each other through the communication. The controller of each air vehicle may be configured to output a notification to inform the driver of the pass and stop signals by displaying the signals through the virtual traffic light, so that the air vehicle may pass through the intersection at the designated point without a collision.

In the embodiment of the present disclosure, the traffic priority of the intersection may be determined based on a distance from the intersection to each air vehicle. The traffic priority may be determined such that an air vehicle located closer to the intersection is guided to pass through the intersection earlier.

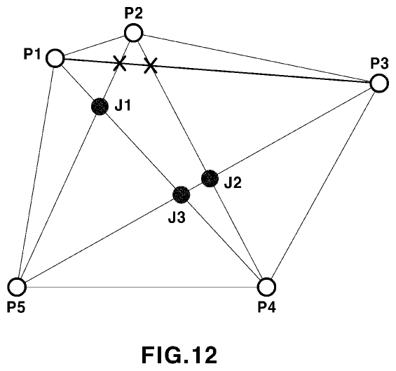

FIG. 12 is a view showing an example of setting the intersection of the VSRL according to the present disclosure, wherein P1 to P5 represent vertiports that are the take-off and landing fields and J1 to J3 represent intersections. Locations marked by X are intersections, but the locations are intersections excluded from the flight path. As shown in the drawing, in consideration of operation efficiency of the VSRL, when the flight path to the destination is set, the controller may guide the air vehicle to detour to a path of P3→P2→P1 not to use a path including the intersections marked by X, so that the air vehicle moving from P3 to P1 may pass the optimized number of intersections.

The controller may allow a function same as the lane following assist (LFA) system applied to the conventional automobile to be performed by using the VSRL. The controller 200 may be configured to perform the location control to prevent the air vehicle 1 from deviating from the road (flight path) guided in the VSRL by the driving control of the driver, and for example, the controller 200 may be configured to perform the steering control preventing the air vehicle 1 from deviating the mad or to warn the driver by operating a warning device in the air vehicle 1 when the air vehicle 1 deviates the mad in the VSRL on the basis of the present location information of the air vehicle 1.

Hereinbelow, a control method of the air vehicle according to an embodiment of the present disclosure will be described in detail with reference to accompanying drawings.

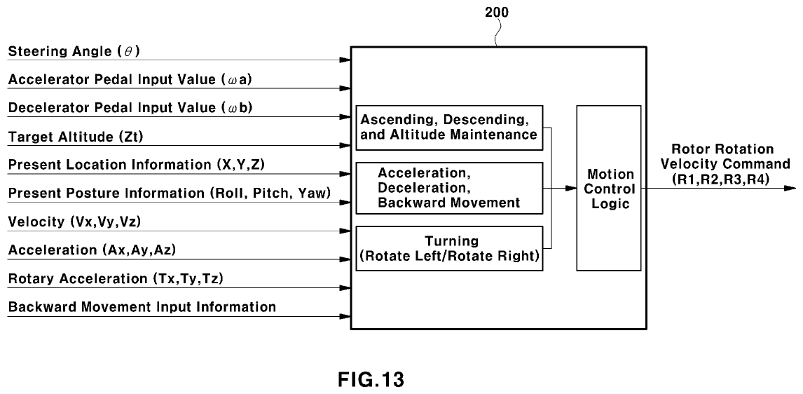

FIG. 13 is a view showing the control method of the air vehicle for the UAM according to the embodiment of the present disclosure, and a control block diagram for performing a motion control of the air vehicle based on real-time driving information collected from the air vehicle during the flight In the air vehicle to which the control method of the present disclosure is applied, the drive device is a plurality of motors that are separately provided to rotors for rotating the rotors, and the drive device in the quadcopter is the 4 motors.

As shown in FIG. 13, the real-time driving information may be collected from the air vehicle, and the real-time driving information may be input to the controller 200. The real-time driving information may include: a steering angle (θ) detected by the steering angle sensor 112, an accelerator pedal input value (ωₐ) detected by the accelerator pedal sensor 122, a decelerator pedal input value (ω_{b}) detected by the decelerator pedal sensor 132, a target altitude value (Zt) in response to the operation of the altitude designating device 140, real-time air vehicle altitude information (Z) detected by the altitude sensor 155, real-time air vehicle location information (X, Y) acquired by the location information acquirement part 151, real-time air vehicle posture information (roll, pitch, yaw value) detected by the posture sensor 154, an air vehicle velocity (Vx, Vy, Vz) detected by the velocity sensor 153, and air vehicle acceleration (Ax, Ay, Ax) and air vehicle rotary acceleration (Tx, Ty, Tz) detected by the acceleration sensor 152. In addition, the real-time driving information may include backward movement input information that is input as the driver operates a backward movement control device 156.

Accordingly, the controller 200 may be configured to perform the control for ascending, descending, and altitude maintaining of the air vehicle in response to the control logic preset based on the driving information input as described above, perform the control for acceleration, deceleration, and backward movement, and perform the turning (steering) control for left turn and right turn.

For performing the controls, the control logic of the controller 200 may be configured to generate a control command (R1, R2, R3, R4) value for each of the rotors based on the driving information, and the controller 200 may be configured to operate each of the motors 311 to 314 in response to the generated control command value. A control command (R1, R2, R3, R4) for controlling the drive of each of the motors 311 to 314 may be a rotation velocity command, and the rotor rotation velocity command (R1, R2, R3, R4) refers to a motor rotation velocity command in FIG. 13 and the motor rotation velocity command becomes a control command value for controlling motor drive.

In the electric drone such as the quadcopter capable of being used as the air vehicle for UAM, the drive device for flight is the motors rotating the rotors, so the controller operates the drive of each of the motors rotating the rotors in response to the control command value. An inverter may be used for the drive and control of the motors.

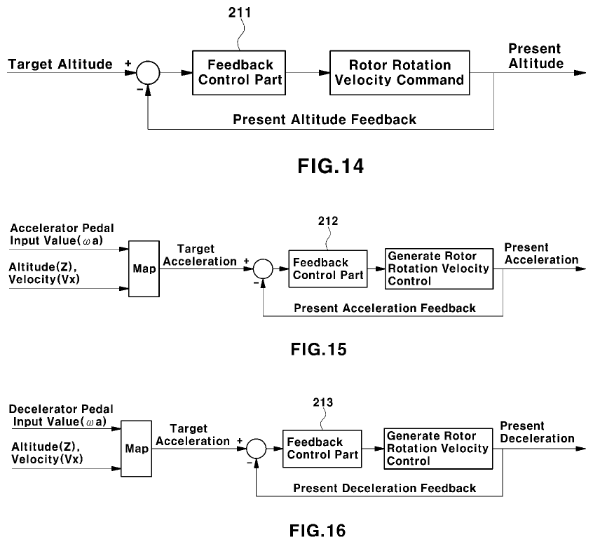

FIG. 14 is a view showing an algorithm of control logic for ascending and descending, and maintaining altitude of the air vehicle according to the embodiment of the present disclosure, and illustrates a state of performing a rotor rotation velocity feedback control by which the air vehicle ascends and descends to, and maintains at the target altitude (Zt).

When the driver operates the altitude designating device 140 to select and designate the flight altitude to be desired (hereinbelow, which is referral to ‘target altitude’), the controller 200 may be configured to perform the feedback control for controlling the altitude of the air vehicle to the target altitude using a value of the target altitude (Zt) and real-time air vehicle altitude (Z) information detected by the altitude sensor 155.

The real-time air vehicle altitude (Z) value detected by the altitude sensor 155 becomes a feedback input value, and a feedback control part 211 in the controller 200 performs the feedback control using the target altitude (Zt) and information about the present altitude (Z) value that is the feedback input value. The feedback control part 211 may be configured to generate and output a control command value for maintaining an air vehicle altitude value to the target altitude, i.e. generate and output a rotor (motor) rotation velocity command (R1, R2, R3, R4).

As described above, as the driving of the rotors (motors) is controlled in response to the control command value generated by the feedback control part 211, the air vehicle may maintain the target altitude, and the ascending and descending control of the air vehicle may be performed so that the present altitude follows the target altitude. A controller, such as PID (proportional-integral-differential), lead-lad, Kalman filter, etc., may be used as the feedback control part 211 depending on characteristics of the system.

FIGS. 15 and 16 are views showing an algorithm of control logic for acceleration and deceleration of the air vehicle according to the embodiment of the present disclosure. FIG. 15 illustrates a state of performing the acceleration control of the air vehicle in response to the accelerator pedal input value (ωₐ), and FIG. 16 illustrates a state of performing the deceleration control of the air vehicle in response to the decelerator pedal input value (ω_{b}).

As shown in FIG. 15, during the acceleration control, the controller 200 may be configured to determine target acceleration using the driving information collected from the air vehicle, i.e. by using the accelerator pedal input value (ωₐ), and the present altitude (Z) and velocity (Vx) information of the air vehicle as the input information. The controller 200 may be configured to receive and store setting data used to determine the target acceleration from the input information in advance.

The setting data is data defining correlation between the input information (accelerator pedal input value, altitude and velocity of air vehicle) and the target acceleration, and may be a map in which the target acceleration is set as a value corresponding to the accelerator pedal input value (ωₐ) and the altitude (Z) and the velocity (Vx) of the air vehicle. The controller 200 may determine the target acceleration corresponding to a present accelerator pedal input value (ωₐ) and the present air vehicle altitude (Z) and the velocity (Vx) by using the map.

A feedback control part 212 of the controller 200 uses the target acceleration determined above as a target value and uses present air vehicle longitudinal acceleration (Ax) detected by the acceleration sensor 152 (longitudinal acceleration sensor) as a feedback value to generate and output the control command (R1, R2, R3, R4) for allowing longitudinal acceleration of the air vehicle to follow the target acceleration.

As shown in FIG. 16, during the deceleration control, the controller 200 may be configured to determine target deceleration using the driving information collected from the air vehicle, i.e. a decelerator pedal input value (ω_{b}), and a present air vehicle altitude (Z) and velocity (Vx) information as the input information. The controller 200 may be configured to receive and store setting data used to determine the target deceleration from the input information in advance.

The setting data defines correlation between the input information (decelerator pedal input value, altitude and velocity of air vehicle) and the target deceleration, and may be a map in which the target deceleration is set as a value corresponding to the decelerator pedal input value (ω_{b}) and the altitude (Z) and the velocity (Vx) of the air vehicle. Whereby, the controller 200 may determine the target deceleration corresponding to the present decelerator pedal input value (ω_{b}) and a present air vehicle altitude (Z) and velocity (Vx) by using the map.

A feedback control part 213 of the controller 200 uses the target deceleration determined above as a target value and uses air vehicle longitudinal deceleration (Ax) detected by the acceleration sensor 152 (longitudinal acceleration sensor) as a feedback value to generate and output a control command (R1, R2, R3, R4) for allowing longitudinal deceleration of the air vehicle to follow the target deceleration. Therefore, during the acceleration and deceleration control, in response to the control command (R1, R2, R3, R4) value generated and output from the feedback control part 212, 213, i.e. a rotor (motor) rotation velocity command value, drive of each of the motors 311 to 314 that are the drive device of the air vehicle is controlled, thereby air vehicle's acceleration or deceleration flight corresponding to the driver's pedal input value (ωₐ, ω_{b}) may be performed.

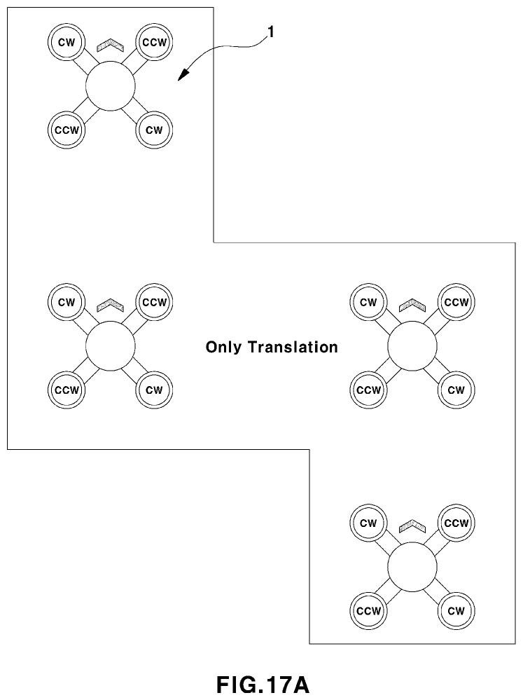

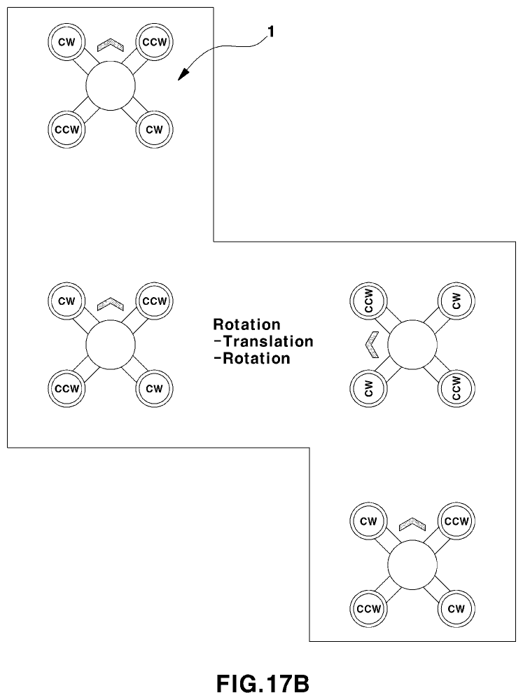

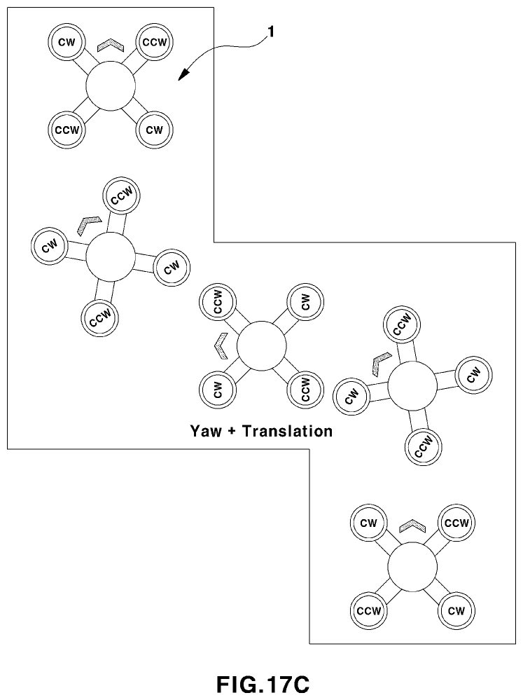

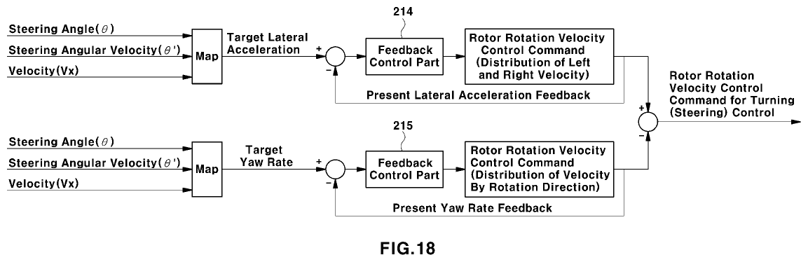

Next, FIGS. 17A, 17B, and 17C are views showing comparison between a turning method of the conventional drone and a turning method of the air vehicle for UAM according to the present disclosure, wherein FIGS. 17A and 17B show turning states of the conventional drone and FIG. 17C shows a turning state of the air vehicle for UAM according to the present disclosure.

An only translation method as shown in FIG. 17A or a translation+rotation combination method as shown in FIG. 17B are used as the turning method of the conventional drone. However, with the turning method of the conventional drone, the purpose of movement may be achieved, but the passengers may feel discomfort such as motion sickness and dizziness due to the motion of an unfamiliar air vehicle.

On the other hand, the present disclosure is configured such that the turning motion and movement of the air vehicle are performed in a way similar to a way of operating a steering wheel in the conventional automobile. In other words, to complement the shortcomings of the motion of the conventional drone and to improve control performance and ease of control, a form of the steering device of the conventional automobile familiar to the driver is adopted as the main HMI, and the air vehicle may perform the turning movement in a similar form to a turning form in the conventional automobile by the steering input method similar to the conventional automobile.

As shown in FIG. 17C, the air vehicle of the present disclosure performs the turning driving while simultaneously performing the yaw movement and forward movement like driving the conventional automobile (simultaneous translation and rotation). When the driver controls the steering wheel 111 while looking forward from the driver seat, the air vehicle 1 moves forward with the yaw movement in a direction where the driver performs the steering of the air vehicle with the control of the steering wheel and performs the turning flight such that the air vehicle alternately performs a left turn and a right turn and simultaneously moves forward like the conventional automobile passing through a narrow alley.

FIG. 18 is a view showing an algorithm of control logic for the turning flight according to the embodiment of the present disclosure, and is a control block diagram showing the steering control (turning control) for the air vehicle with a steering angle (θ), a steering angular velocity (θ′), and an air vehicle velocity (Vx) as an input.

During the turning control as shown in FIG. 17C, as the driving information collected from the air vehicle 1, the controller 200 may be configured to receive the steering input information in response to the driver's steering wheel control, i.e. the real-time steering angle (θ) information detected by the steering angle sensor 112 and simultaneously receive the real-time air vehicle velocity (Vx) information detected by the velocity sensor 153. The controller 200 may use the steering angular velocity (θ′) information obtained by differentiating a steering angle signal as the steering input information.

The controller may be configured to determine the target lateral acceleration and the target yaw rate value from the information about steering angle (θ), steering angular velocity (θ′), and air vehicle velocity (Vx) by using the setting data. The setting data may include a first map in which the target lateral acceleration is set as a value corresponding to steering angle, steering angular velocity, and air vehicle velocity and a second map in which the target yaw rate is set as a value corresponding to steering angle, steering angular velocity, and air vehicle velocity. Accordingly, with inputting the steering angle, steering angular velocity, and air vehicle velocity, the target lateral acceleration may be determined from the first map of the controller and the target yaw rate may be determined from the second map thereof.

The feedback control parts 214 and 215 of the controller 200 use the target lateral acceleration and target yaw rate determined above as a respective target value, and use air vehicle lateral acceleration (Ay) detected by the acceleration sensor 152 (lateral acceleration sensor) and a yaw rate value detected by the posture sensor 154 as a feedback value, to generate and output the control command (R1, R2, R3, R4) value for allowing the lateral acceleration and yaw rate of the air vehicle to respectively follow the target lateral acceleration and the target yaw rate.

A final control command (R1, R2, R3, R4) value for the steering control is generated by the controller 200, based on the control command value output by the feedback control part 214 performing the feedback control to the air vehicle lateral acceleration and the control command value output by the feedback control part 215 performing the feedback control to the air vehicle yaw rate.

Therefore, during the turning and steering control of the air vehicle 1, in response to the final control command (R1, R2, R3, R4) value generated and output by the controller, i.e., the rotor (motor) rotation velocity command value, the driver of each of the motors 311 to 314 that are the drive device of the air vehicle is controlled, so that performing the turning and steering of the air vehicle corresponding to the drivers steering input value may be performed.

As described above, with the control system of the air vehicle for UAM according to the present disclosure, the vertical take-off and landing process is automated, and the steering wheel and the accelerator pedal and the decelerator pedal that are familiar as the driver drives the conventional automobile are applied to the control system, so that the driver may operate the air vehicle with the same method and principle as the conventional automobile and people may more easily operate the air vehicle that has previously driven by only highly trained and specialized experts.

Although the exemplary embodiment of the present invention has been described for illustrative purposes, those skilled in the art will appreciate that various modifications, additions and substitutions are possible, without departing from the scope and spirit of the present invention as disclosed in the accompanying claims.

What is claimed is:

1. A control system of an air vehicle for urban air mobility, comprising:
a steering wheel configured to be operated for steering of the air vehicle;
an accelerator pedal configured to be operated for acceleration of the air vehicle;
a decelerator pedal configured to be operated for deceleration and braking of the air vehicle;
an altitude designating device configured to select and designate a target altitude where the air vehicle flies;
a controller configured to generate a control command for adjusting altitude, acceleration, deceleration and braking, and steering of the air vehicle, based on air vehicle driving information including driving input information in response to the operation of the steering wheel, the accelerator pedal, the decelerator pedal, and the altitude designating device; and
a drive device configured to operate according to the control command generated from the controller.

2. The control system of claim 1, wherein the controller is configured to perform a control for maintaining the altitude of the air vehicle to the designated target altitude while adjusting acceleration, deceleration and braking, and steering of the air vehicle.

3. The control system of claim 2, further comprising:
an altitude sensor configured to detect an altitude of the air vehicle,
wherein the controller is configured to perform, during take-off of the air vehicle, a control to vertically raise the air vehicle until the altitude of the air vehicle detected by the altitude sensor reaches the designated target altitude.

4. The control system of claim 2, further comprising:
an altitude sensor configured to detect an altitude of the air vehicle,
wherein the controller is configured to perform, during landing of the air vehicle, a control to vertically lower the air vehicle until the altitude of the air vehicle detected by the altitude sensor reaches another target altitude changed by operating the altitude designating device.

5. The control system of claim 1, further comprising:
an accelerator pedal sensor configured to detect an accelerator pedal input value in response to an operation state of the accelerator pedal;
a decelerator pedal sensor configured to detect an a decelerator pedal input value in response to an operation state of the decelerator pedal;
an altitude sensor configured to detect an altitude of the air vehicle; and
a velocity sensor configured to detect a velocity of the air vehicle,
wherein the controller is configured to adjust acceleration and deceleration of the air vehicle, based on the accelerator pedal input value, the decelerator pedal input value, and the altitude and velocity information of the air vehicle.

6. The control system of claim 1, further comprising:
a steering angle sensor configured to detect steering input information in response to an operation state of the steering wheel;
an acceleration sensor configured to detect lateral acceleration of the air vehicle; and
a posture sensor configured to detect a yaw rate of the air vehicle,
wherein the controller is configured to determine target lateral acceleration and a target yaw rate, based on the steering input information detected by the steering angle sensor, and
to generate a control command for controlling such that the lateral acceleration of the air vehicle detected by the acceleration sensor follows the target lateral acceleration, and a control command for controlling such that the yaw rate of the air vehicle detected by the posture sensor follows the target yaw rate.

7. The control system of claim 6, further comprising:
a velocity sensor configured to detect a velocity of the air vehicle,
wherein the steering input information includes a steering angle and a steering angular velocity acquired from a signal of the steering angle sensor, and
the controller is configured to determine the target lateral acceleration and the target yaw rate, which correspond to the acquired steering angle and steering angular velocity and the detected velocity of the air vehicle, from respective maps.

8. The control system of claim 1, further comprising:
a location information acquirement part configured to acquire location information of the air vehicle; and
a display mounted within the air vehicle,
wherein the controller is configured to operate the display, such that the display displays a virtual spatial mad layer representing the designated target altitude and simultaneously displays a present location of the air vehicle acquired by the location information acquirement part on the virtual spatial road layer.

9. The control system of claim 8, wherein the virtual spatial mad layer is roads preset in virtual layers of planes per altitude, and the virtual spatial road layer displayed on the display is configured such that, straight lines represent the roads and an intersection of the straight lines represents an intersection of the roads or a take-off and landing field in which the air vehicle may perform take-off and landing.

10. The control system of claim 9, wherein the controller is configured to generate a control command for adjusting steering of the air vehicle based on the present location information acquired by the location information acquirement part so that the air vehicle does not deviate from the roads displayed on the virtual spatial road layer.

11. The control system of claim 9, wherein the controller is configured to operate a warning device in the air vehicle to provide a warning to a driver when the air vehicle deviates from the roads displayed on the virtual spatial road layer based on the present location information acquired by the location information acquirement part

12. The control system of claim 9, wherein the controller is configured to communicate with a controller of a second air vehicle to share location information of the air vehicles with each other and simultaneously determine a traffic priority of passing the intersection based on the location information of the air vehicles, and to share the determined traffic priority through communication with the controller of the second air vehicle, and to display a passing signal or a stop signal at the intersection by a virtual traffic light on the virtual spatial road layer.
